(19) United States
(12) Patent Application Publication
(10) Pub. No.: US 2026/0094880 A1
(43) Pub. Date: Apr. 2, 2026

(54) COMPOSITE MODULE COMPRISING AN ULTRASONIC ELECTRODE CORE CASCADE AND A SEPARATOR

(71) Applicant: Zhijun PENG, Foshan (CN)

(72) Inventor: Zhijun PENG, Foshan (CN)

(21) Appl. No.: 19/015,581

(22) Filed: Jan. 9, 2025

(30) Foreign Application Priority Data
Oct. 2, 2024 (CN) 2024113874549

(51) Int. Cl. H01M 10/42; H01M 10/0525; H01M 10/058; H01M 10/615; H01M 10/654; H01M 10/657; H01M 50/103; H01M 50/15; H01M 50/186; H01M 50/46; H01M 50/469; H01M 50/55; H01M 50/636; H01M 50/691

(52) U.S. Cl. CPC H01M 10/4235; H01M 10/0525; H01M 10/058; H01M 10/4214; H01M 10/615; H01M 10/654; H01M 10/657; H01M 50/103; H01M 50/15; H01M 50/186; H01M 50/46; H01M 50/469; H01M 50/55; H01M 50/636; H01M 50/691

(57) ABSTRACT

A composite module, having a separator body, a plurality of first ultrasonic electrode cores, and a plurality of second ultrasonic electrode cores; the first ultrasonic electrode cores are positioned on an inner circumferential surface of the separator body and spaced apart with one another; the first ultrasonic electrode cores are integrally packaged with the separator body; one ends of the first ultrasonic electrode cores are connected in parallel through first conductive wires to form a first wiring terminal; the second ultrasonic electrode cores are positioned on an outer circumferential surface of the separator body and spaced part with one another; the second ultrasonic electrode cores are integrally packaged with the separator body; one ends of the second ultrasonic electrode cores are connected in parallel through second conductive wires to form a second wiring terminal.

### BACKGROUND OF THE INVENTION

The present invention relates to the technical field of batteries, and in particular to a composite module comprising an ultrasonic electrode core cascade and a separator.

At present, a lithium-ion battery mainly comprises a positive electrode (LiMn2O4 material), a negative electrode (graphite material), electrolyte solution and a separator. When the battery is charged by a power source, electrons on the positive electrode move through an external circuit to the negative electrode, and lithium ions move from the positive electrode into the electrolyte solution, pass through small curved holes on the separator, reach the negative electrode, and combine with the electrons that move to the negative electrode earlier before. When the battery is discharging, the electrons on the negative electrode move through the external circuit to the positive electrode, and the lithium ions move from the negative electrode into the electrolyte solution, pass through the small curved holes on the separator, reach the positive electrode, and then combine with the electrons that move to the positive electrode earlier before.

A battery core of an existing lithium-ion battery is disclosed, for example, in CN214672874U (application No. 202120917584.4) titled “ELECTRODE ASSEMBLY, BATTERY CELL, BATTERY, AND POWER DEVICE”, wherein the electrode assembly (i.e., the battery core) of this prior patent is formed by layers of positive electrode plates and negative electrode plates alternately laminated and wound for numerous times into a coil, where a layer of separator is also disposed between every two adjacent positive electrode plate layer and a negative electrode plate layer; the resulting wound coil is formed as a substantially solid cylindrical body. The battery core structure of this kind has some major disadvantages:

Firstly, because operation of the lithium-ion battery is accompanied by chemical reactions between materials, lithium metal crystals and impurities resulted from the chemical reactions may easily grow at the electrode plates, and their amount may continuously increase along with the service time of the lithium-ion battery. However, there is no space inside this kind of lithium-ion battery core with such a solid structure to accommodate the lithium metal crystals and the chemical impurities, and so the lithium metal crystals and the chemical impurities will adhere to the separators and the electrode plates, thereby forming barriers which do not only block the movements of lithium ions, resulting in the loss of battery capacity and the reduction of charge and discharge efficiency, but also pierces through the separators and hence resulting in great safety hazards due to direct communication between the positive electrode plates and the negative electrode plates that causes short circuit and burning of the battery.

Secondly, in a battery core of such a solid structure, the electrolyte can only be stored between a separator and a corresponding electrode plate by electrolyte infiltration, therefore, the amount of electrolyte stored in each battery core is small, which greatly affects the number of charge and discharge cycle of the lithium-ion battery, and results in a short service life of the lithium-ion battery.

Thirdly, in the charge or discharge process of such a battery core with a solid structure, it is difficult for the lithium-ion battery to dissipate heat to the external environment, and this leads to great safety hazards due to a quick rise of the temperature in the lithium-ion battery core. Therefore, it is necessary to equip a more powerful heat dissipation and cooling system during use of the lithium-ion battery core. However, operation of the heat dissipation and cooling system may consume part of the electricity stored in the battery, thereby resulting in a short endurance time of the lithium-ion battery.

Fourthly, because an environmental temperature for operation of a lithium-ion battery is 0-40° C. When the environmental temperature is lower than 0° C., the capillaries, also commonly known as “small holes”, on the separator shrink due to the principle of thermal expansion and contraction. Therefore, the lithium ions are difficult or unable to pass through the separator; also, the lithium ions may easily condense in the electrolyte solution and move slowly in the electrolyte solution; as a result, the lithium ion battery cannot be charged and discharged normally, and the overall performance of the battery will be weakened. In this regard, the current solution is to heat up the lithium-ion battery by using a heat dissipation and cooling system. However, operation of the heat dissipation and cooling system may consume part of the electricity stored in the battery, therefore resulting in a short endurance of the lithium-ion battery.

In summary, there are still many problems to be solved in the current battery core having a solid structure.

### BRIEF SUMMARY OF THE INVENTION

The present invention intends to solve the above problems and disadvantages by providing a composite module comprising an ultrasonic electrode core cascade and a separator; the composite module is formed by positioning ultrasonic electrode cores spaced apart from one another on the inner and outer circumferential surfaces of a separator body and integrally packaging the ultrasonic electrode cores with the separator body. Gaps exist on the separator body due to the ultrasonic electrode cores being spaced apart, such that when the composite module is packaged into a battery product, more spaces are formed inside the battery to increase the storage spaces for the electrolyte and to rapidly conducting the heat generated during operation of the battery to the external environment. In addition, a larger space is therefore provided to accommodate lithium metal crystals and chemical impurities generated during operation of the battery; further, the ultrasonic electrode cores mounted with the ultrasonic elements can create an ultrasonic cavitation effect such that the lithium metal crystals and the chemical impurities will not be bonded to the separator, thereby avoiding the hazards of blocking and puncturing the separator by the lithium metal crystals and the chemical impurities, thereby greatly improving the safety of the battery, and prolonging the service life of the battery. Moreover, movement of the electrolyte can be accelerated by the ultrasonic cavitation effect, such that the charging speed is accelerated, and the battery can be quickly heated up from inside by utilizing the ultrasonic cavitation effect during extremely cold weather.

The technical solutions of the present invention are achieved as follows: A composite module, comprising ultrasonic electrode cores in-built with ultrasonic elements, and a separator body; said ultrasonic electrode cores comprises a plurality of first ultrasonic electrode cores and a plurality of second ultrasonic electrode cores; the first ultrasonic electrode cores are positioned on an inner circumferential surface of the separator body and spaced apart with one another; the first ultrasonic electrode cores are integrally packaged with the separator body; one ends of the first ultrasonic electrode cores are connected in parallel through first conductive wires to form a first wiring terminal; the second ultrasonic electrode cores are positioned on an outer circumferential surface of the separator body and spaced part with one another; the second ultrasonic electrode cores are integrally packaged with the separator body; one ends of the second ultrasonic electrode cores are connected in parallel through second conductive wires to form a second wiring terminal.

Further, the separator body is a hollow cylindrical separator body having said inner circumferential surface and said outer circumferential surface.

Further, two fixing plates are positioned at an upper end and a lower end of the separator body respectively; the upper end and the lower end of the separator body, two ends of the first ultrasonic electrode cores, and two ends of the second ultrasonic electrode cores are connected to the two fixing plates such that the separator body, the first ultrasonic electrode cores, and the second ultrasonic electrode cores are sandwiched between the two fixing plates and fixed with the two fixing plates to form an integral hollow battery core body.

Further, a circumferential edge of the upper end of the separator body and a circumferential edge of the lower end of the separator body are each provided with a fitting protrusion; each of the two fixing plates is correspondingly provided with a fitting groove which is sealingly inserted by a corresponding fitting protrusion.

The present invention has the following beneficial effects: The composite module is formed by positioning ultrasonic electrode cores spaced apart from one another on the inner and outer circumferential surfaces of a separator body and integrally packaging the ultrasonic electrode cores with the separator body. Therefore, gaps exist on the separator body due to the ultrasonic electrode cores being spaced apart, such that when the composite module is packaged into a battery product, more spaces are formed inside the battery to increase the storage spaces for the electrolyte and to improve the storage capacity of the battery. In addition, by promulgation of ultrasonic waves through the electrolyte and an ultrasonic cavitation effect generated during operation of the ultrasonic electrode cores mounted with the ultrasonic elements, the heat generated inside the battery during operation may be facilitated to be conducted to the external environment, thereby improving the cooling performance of the battery. Besides, the gaps inside the battery can accommodate lithium metal crystals and chemical impurities generated during operation of the battery, and the ultrasonic electrode cores mounted with the ultrasonic elements generate said ultrasonic cavitation effect such that the lithium metal crystals and the chemical impurities will not be bonded to the separator, thereby avoiding the hazards of blocking and puncturing the separator by the lithium metal crystals and the chemical impurities, greatly improving the safety of the battery, and prolonging the service life of the battery. Moreover, movement of the electrolyte can be accelerated by the ultrasonic cavitation effect, and so as the movement of the lithium ions, therefore the charging speed of the battery is accelerated. Furthermore, the structural design of the arrangement of a plurality of ultrasonic electrode cores can also greatly improve the charging power and the discharging power of the battery; accelerating the movement of the electrolyte can also avoid and solve the problem that the battery cannot be charged or discharged due to poor fluidity and coagulation during extremely cold weather. The present invention is suitable for producing chemical batteries such as lithium-ion batteries, carbon-zinc batteries, alkaline batteries, lithium-manganese batteries, lithium thionyl chloride batteries, zinc-manganese batteries, zinc-silver batteries, zinc-air batteries, lithium-iron batteries, lead-acid storage batteries, and nickel-hydrogen storage batteries.

### BRIEF DESCRIPTION OF THE DRAWINGS

FIG. 1 is a schematic diagram of an overall structure of the present invention;

FIG. 2 is a schematic exploded structural view of the present invention;

FIG. 3 is a schematic cross-sectional view at A-A in FIG. 1 of the present invention;

FIG. 4 is a schematic cross-sectional view of another technical solution of the present invention;

FIG. 5 is a schematic diagram of an exploded structure of two fixing plates and a hollow cylindrical separator body according to the present invention;

FIG. 6 is a schematic perspective view of a cover shell of the present invention;

FIG. 7 is a schematic perspective view of a housing of the present invention;

FIG. 8 is a schematic diagram of an overall structure of a first ultrasonic electrode core or a second ultrasonic electrode core of the present invention;

FIG. 9 is a schematic diagram of an exploded structure of a first ultrasonic electrode core or a second ultrasonic electrode core of the present invention; and

FIG. 10 is a schematic cross-sectional view of a first ultrasonic electrode core or a second ultrasonic electrode core of the present invention.

### DETAILED DESCRIPTION OF THE INVENTION

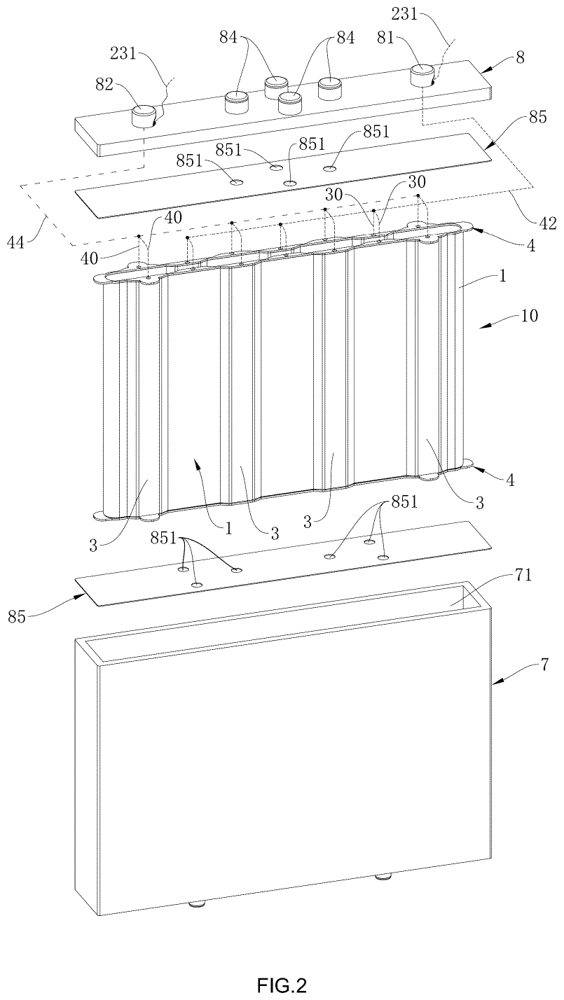

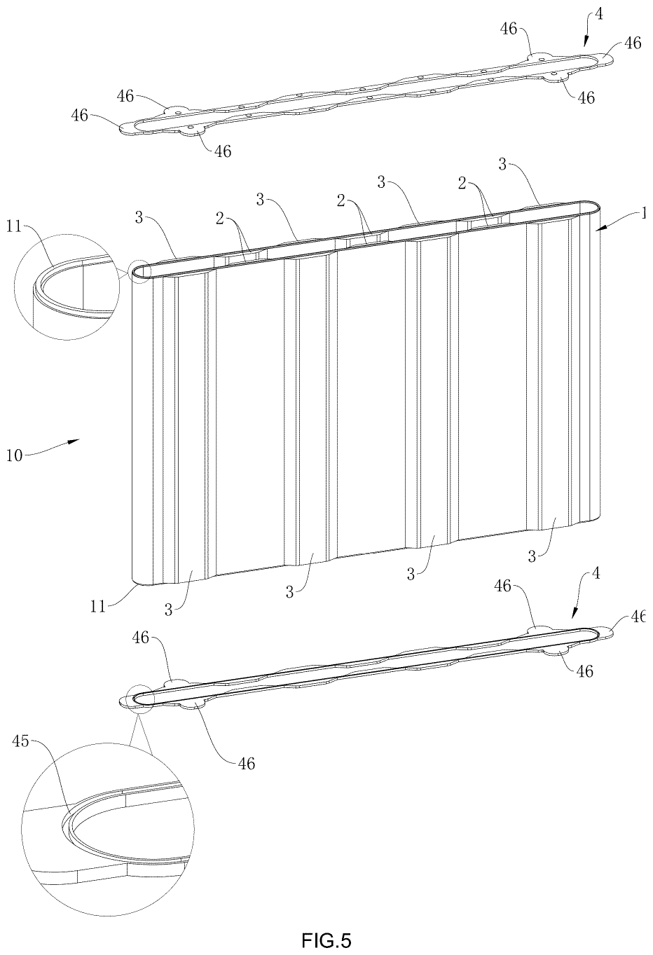

The present invention relates to a composite module comprising an ultrasonic electrode core cascade and a separator. Said composite module is a battery core module assembly used for assembling an ultrasonic battery product. Said composite module comprises ultrasonic electrode cores in-built with ultrasonic elements; for the ease of describing the structures of the present invention clearly, said ultrasonic electrode cores of the present invention will be described as first ultrasonic electrode cores and second ultrasonic electrode cores below. The separator of the present invention is the same as a conventional battery separator. The battery separator, embodied as a film, is positioned between a positive electrode and a negative electrode of the battery, and is a critical component of the battery, and has a direct impact on the safety and the cost of the battery. A main function of the battery separator is to isolate the positive electrode and the negative electrode, such that electrons in the battery cannot pass through the separator directly, but ions in the electrolyte are allowed to pass through the separator freely between the positive electrode and the negative electrode. In order to achieve the purposes of the present invention, as shown in FIGS. 2 and 5, the composite module comprises a separator body 1, a plurality of first ultrasonic electrode cores 2, and a plurality of second ultrasonic electrode cores 3. The first ultrasonic electrode cores 2 are positioned on an inner circumferential surface of the separator body 1 and spaced apart with one another; the first ultrasonic electrode cores 2 are integrally packaged with the separator body 1; the first ultrasonic electrode cores 2 have their respective one ends connected in parallel through first conductive wires 30 to form a first wiring terminal 42. The second ultrasonic electrode cores 3 are positioned on an outer circumferential surface of the separator body 1 and spaced part with one another; the second ultrasonic electrode cores 3 are integrally packaged with the separator body 1; the second ultrasonic electrode cores 3 have their respective one ends connected in parallel through second conductive wires 40 to form a second wiring terminal 44. Both the first ultrasonic electrode cores 2 can be used as one of the positive electrode and the negative electrode, and the second ultrasonic electrode cores 3 can be used as another one of the positive electrode and the negative electrode, depending on the practical application.

In order to make it easier for the above technical solutions to be packaged into a module body, and thus to better install the module body into a battery housing when the module body is later used to make a battery, as shown in FIGS. 2 to 5, the separator body 1 is a hollow cylindrical separator body having said inner circumferential surface and said outer circumferential surface.

In order to increase the strength of the hollow cylindrical separator body and make it into a fixed shape, as shown in FIGS. 2 and 5, the present invention further comprises two fixing plates 4 positioned at an upper end and a lower end of the separator body 1 respectively; the upper end and the lower end of the separator body 1, two ends of the first ultrasonic electrode cores 2, and two ends of the second ultrasonic electrode cores 3 are connected to the two fixing plates 4 such that the separator body 1, the first ultrasonic electrode cores 2, and the second ultrasonic electrode cores 3 are sandwiched between the two fixing plates 4 and fixed with the two fixing plates 4 to form an integral hollow battery core body 10. Further, in order to seal the upper end and the lower end of the separator body 1 with the two fixing plates 4 respectively, as shown in FIG. 5, a circumferential edge of the upper end of the separator body 1 and a circumferential edge of the lower end of the separator body 1 are each provided with a fitting protrusion 11; each of the two fixing plates 4 is correspondingly provided with a fitting groove 45 which is sealingly inserted by a corresponding fitting protrusion 11; by cooperative engagement between the fitting groove 45 and the corresponding fitting protrusion 11, the two can be easily fixed with each other, thereby facilitating assembly and enabling the separator body 1 to separate the first ultrasonic electrode cores 2 from the second ultrasonic electrode cores 3 to prevent short circuit of the battery. In order to better ensure the sealing performance between the fitting groove 45 and the corresponding fitting protrusion 11, an adhesive can be added therebetween for stronger bonding once cured.

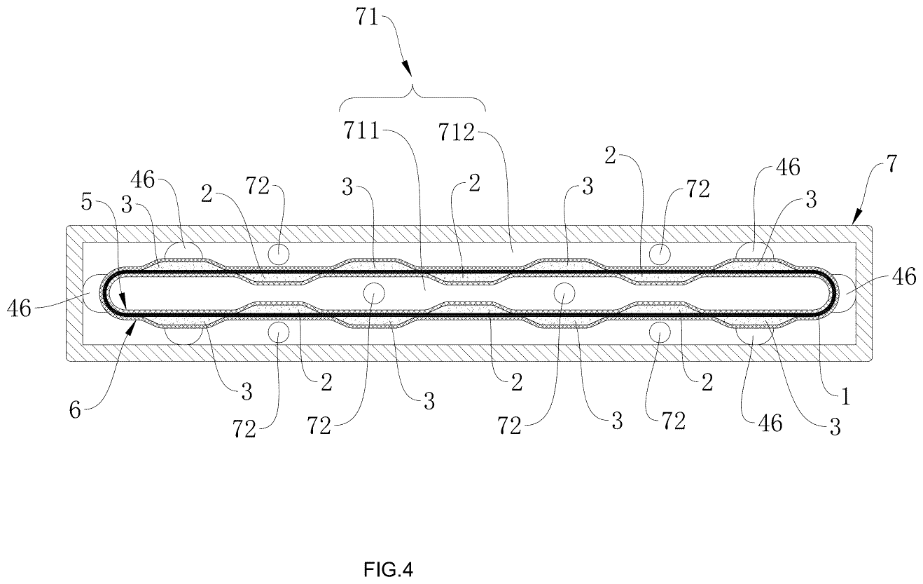

On the basis of the above solution, the present invention further provides the following technical solutions: As shown in FIG. 4, the composite module also comprises a first electrode plate 5 and a second electrode plate 6. The first electrode plate 5 is formed to cover the inner circumferential surface of the separator body 1, and the second electrode plate 6 is formed to cover the outer circumferential surface of the separator body 1. By providing the first electrode plate 5 and the second electrode plate 6, contact areas between the electrodes and the electrolyte can be greatly increased, such that the charge and discharge efficiency as well as energy density of the battery can be greatly improved.

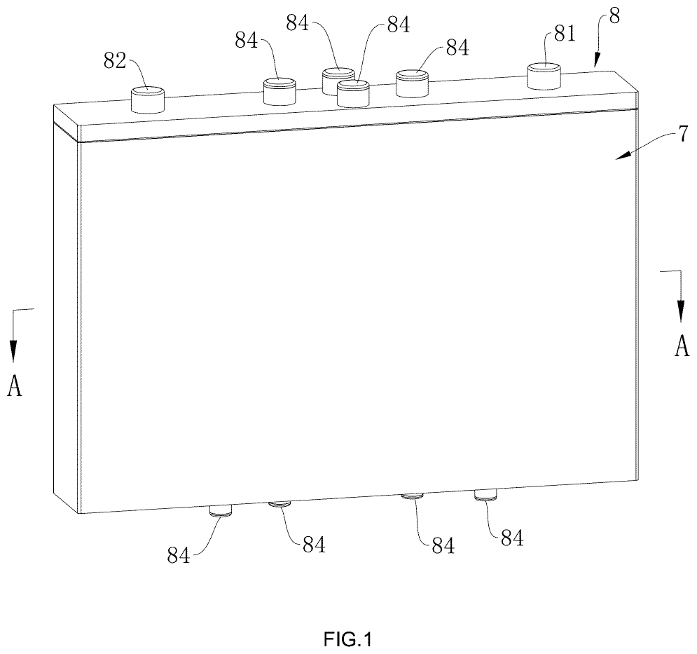

In order to package the structures described above into a complete battery, as shown in FIGS. 1 and 2, the present invention further comprises a housing 7 with an accommodating cavity 71, and a cover shell 8. The hollow battery core body 10 is nested in the accommodating cavity 71, the accommodating cavity 71 is partitioned by the hollow battery core body 10 into a first working chamber 711 and a second working chamber 712; the cover shell 8 covers an opening of the accommodating cavity 71 of the housing 7, and the cover shell 8 is further provided with a first wiring post 81 and a second wiring post 82 electrically connected to the first wiring terminal 42 and the second wiring terminal 44 respectively. Electrolyte is filled into both the first working chamber 711 and the second working chamber 712. Accordingly, a complete battery is formed. The first working chamber 711 can be used as a positive electrode working chamber of the battery, and correspondingly, the second working chamber 712 can be used as a negative electrode working chamber of the battery.

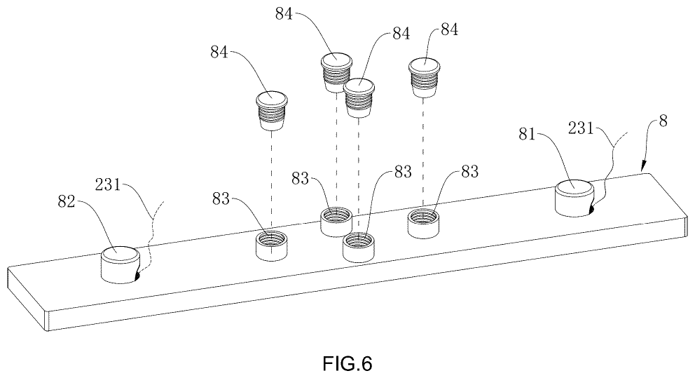

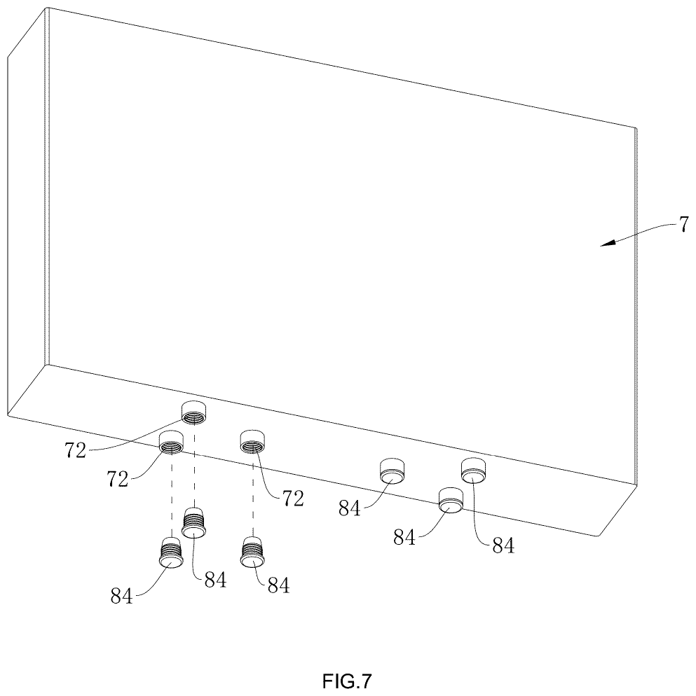

In order to facilitate filling or replenishing of the electrolyte, and to facilitate discharging of used electrolyte when renewing the battery, as shown in FIGS. 6 and 7, the cover shell 8 is further provided with filling ports 83 connected to the first working chamber 711 and the second working chamber 712; a bottom side of the housing 7 is further provided with drain ports 72 connected to the first working chamber 711 and the second working chamber 712; each of the filling ports 83 and the drain ports 72 is provided with a reusable sealing cap 84. The sealing cap 84 is in threaded connection with a corresponding filling port 83 or drain port 72. Further, the electrolyte can be conveniently replaced by utilizing the filling ports 83 and the drain ports 72, further, an interior of the battery can be ultrasonically cleaned by using ultrasonic cavitation effect of the ultrasonic electrode cores during replacement of the electrolyte, such that the service life of the battery can be greatly prolonged through cleaning and renewing the electrolyte.

As shown in FIG. 2, a sealing gasket 85 is further disposed between the hollow battery core body 10 and the cover shell 8, and another sealing gasket 85 is further disposed between the hollow battery core body 10 and an inner bottom surface of the accommodating cavity 71. This further improves the sealing performance and prevents the electrolyte in the first working chamber 711 and the second working chamber 712 from being mixed, so as to further prevent short circuit and improve the safety and reliability of use. During practical application, the shapes of the sealing gaskets 85 and the fixing plates 4 correspond to the shape of the hollow cylindrical separator body 1, in other words, all of them have a hollow structure. Alternatively, one of the two sealing gaskets 85 can be a gasket arranged to cover the opening of the accommodating cavity 71, and another one of the two sealing gaskets 85 is arranged to cover the inner bottom surface of the accommodating cavity 71, and when adopting this alternative structural embodiment, each of the two sealing gaskets 85 is provided with through holes 851 for preventing filling and discharging of liquid from being blocked.

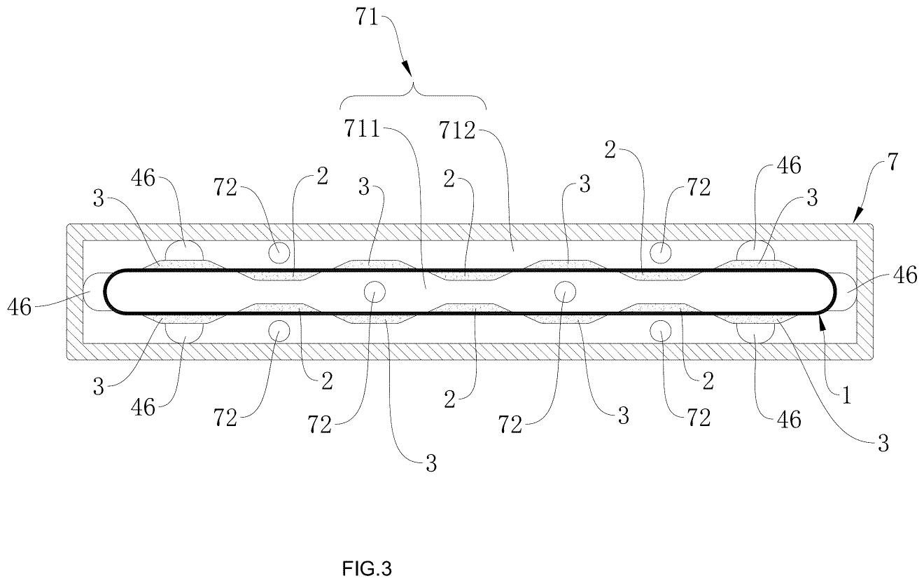

As shown in FIG. 3, a periphery of each of the fixing plates 4 is further provided with positioning projections 46 that are in abutment with an inner side wall of the accommodating cavity 71. In this way, after the hollow battery core body 10 is nested into the accommodating cavity 71, the hollow battery core body 10 can be quickly fixed in place without loosening or wobbling, such that the installation position is more accurate.

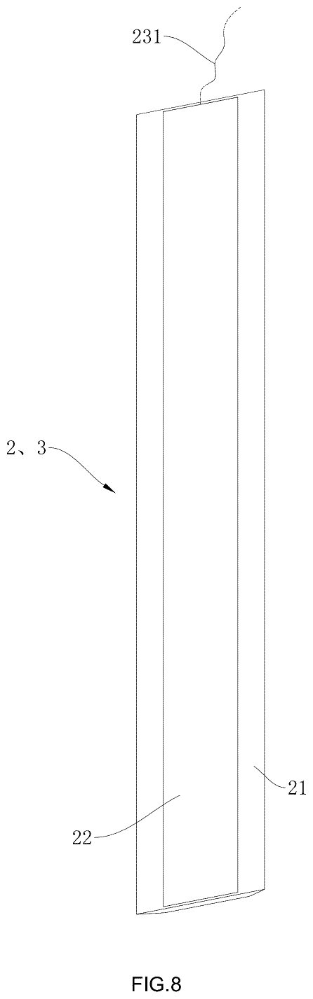

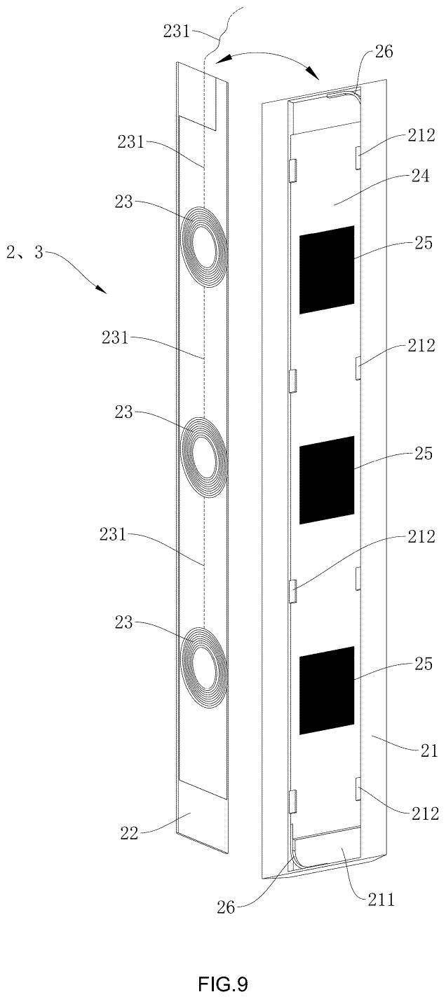

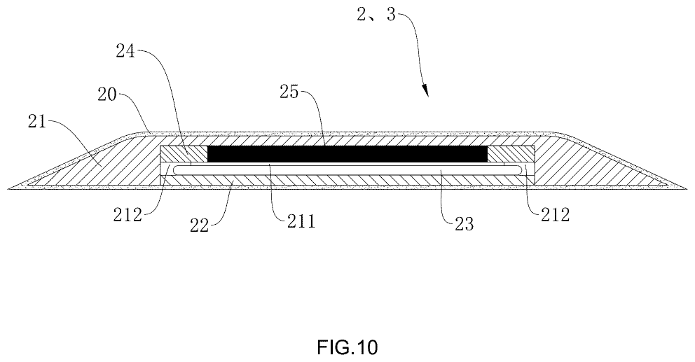

As shown in FIGS. 8, 9, and 10, each of the first ultrasonic electrode cores 2 and the second ultrasonic electrode cores 3 comprises an elongated housing 21 with an operating groove 211, a slidable block 24 disposed in the operating groove 211, and an elongated cover shell 22 covering the operating groove 211. The slidable block 24 is provided with at least one permanent magnet 25; at least one electromagnetic coil 23 interacting with said at least one permanent magnet 25 is arranged at an inner side of the elongated cover shell 22; resilient tabs 26 providing a buffering function are arranged at two ends of the slidable block 24 respectively; outer surfaces of the elongated housing 21 and the elongated cover shell 22 are coated with conductive coating 20. By providing the conductive coating 20, the conductive coating 20 of the first ultrasonic electrode cores 2 and the second ultrasonic electrode cores 3 is electrically conducted with the electrolyte during charge or discharge of the battery. By arranging the resilient tabs 26, when said at least one electromagnetic coil 23 drives said at least one permanent magnet 25 and thus the slidable block 24 to move, the resilient tabs 26 can provide a reactive force to bounce back the slidable block 24, so as to achieve a reciprocating motion. Also, the operating groove 211 is further provided with limiting protrusions 212 for preventing the slidable block 24 from being disengaged from the operating groove 211. The principle of use is as follows: An external circuit energizes said at least one electromagnetic coil 23 through a lead 231, such that when a current flows through said at least one electromagnetic coil 23, a magnetic field is generated, such that said at least one permanent magnet 25 is driven and thus the slidable block 24 is then driven to reciprocate in an ultra-high frequency in the operating groove 211, thereby generating an ultra-high frequency vibration, which propagates in a medium such as a liquid to form ultrasonic waves. The elongated housing 21 and the elongated cover shell 22 are both made of metal materials. As shown in FIGS. 2, 6, 8 and 9, after passing through the elongated cover shell 22, the lead 231 of said at least one electromagnetic coil 23 (of each of the first ultrasonic electrode cores 2 for providing power supply can be wound together with the first conductive wires 30 and the first wiring terminal 42 to form a composite wire, and the lead 231 of said at least one electromagnetic coil 23 (of each of the second ultrasonic electrode cores 3) for providing power supply can be wound together with the second conductive wires 40 and the second wiring terminal 44 to form another composite wire; at the first wiring post 81 and the second wiring post 82, the leads 231 in both composite wires are again separated from the composite wires and then being led out of the housing 7 from sides of the first wiring post 81 and the second wiring post 82 respectively, while the first wiring terminal 42 is then connected with the first wiring post 81 and the second wiring terminal 44 is then connected with the second wiring post 82. In addition to the above-mentioned ultrasonic element (i.e., composed of the slidable block 24, the permanent magnet 25, said at least one electromagnetic coil 23, and the resilient tabs 26), the present invention may alternatively use an ultrasonic vibration motor or an ultrasonic transducer in lieu of the ultrasonic element.

In order to control the ultrasonic elements of the first ultrasonic electrode cores 2 and the second ultrasonic electrode cores 3 to operate, a circuit board module is generally disposed outside the battery housing, and the ultrasonic elements inside the first ultrasonic electrode cores 2 and the second ultrasonic electrode cores 3 are controlled uniformly through a control chip and a control switch of the circuit board module. Also, the circuit board module may be further provided with a Bluetooth® communication module, a WiFi® communication module, or the like. The communication module is used for accessing the Internet, and the battery is monitored and controlled by means of a computer, a smart phone, or the like connected to the Internet.

What is claimed is:

1. A composite module, comprising ultrasonic electrode cores in-built with ultrasonic elements, and a separator body; said ultrasonic electrode cores comprises a plurality of first ultrasonic electrode cores and a plurality of second ultrasonic electrode cores; the first ultrasonic electrode cores are positioned on an inner circumferential surface of the separator body and spaced apart with one another; the first ultrasonic electrode cores are integrally packaged with the separator body; one ends of the first ultrasonic electrode cores are connected in parallel through first conductive wires to form a first wiring terminal; the second ultrasonic electrode cores are positioned on an outer circumferential surface of the separator body and spaced part with one another; the second ultrasonic electrode cores are integrally packaged with the separator body; one ends of the second ultrasonic electrode cores are connected in parallel through second conductive wires to form a second wiring terminal.

2. The composite module of claim 1, wherein the separator body is a hollow cylindrical separator body having said inner circumferential surface and said outer circumferential surface.

3. The composite module of claim 2, wherein two fixing plates are positioned at an upper end and a lower end of the separator body respectively; the upper end and the lower end of the separator body, two ends of the first ultrasonic electrode cores, and two ends of the second ultrasonic electrode cores are connected to the two fixing plates such that the separator body, the first ultrasonic electrode cores, and the second ultrasonic electrode cores are sandwiched between the two fixing plates and fixed with the two fixing plates to form an integral hollow battery core body.

4. The composite module of claim 3, wherein a circumferential edge of the upper end of the separator body and a circumferential edge of the lower end of the separator body are each provided with a fitting protrusion; each of the two fixing plates is correspondingly provided with a fitting groove which is sealingly inserted by a corresponding fitting protrusion.

5. The composite module of claim 2, further comprising a first electrode plate and a second electrode plate; the first electrode plate covers the inner circumferential surface of the separator body, and the second electrode plate covers the outer circumferential surface of the separator body.

6. The composite module of claim 3, further comprising a housing with an accommodating cavity, and a cover shell; the hollow battery core body is nested in the accommodating cavity, the accommodating cavity is partitioned by the hollow battery core body into a first working chamber and a second working chamber; the cover shell covers an opening of the accommodating cavity of the housing, and the cover shell is further provided with a first wiring post and a second wiring post electrically connected to the first wiring terminal and the second wiring terminal respectively.

7. The composite module of claim 6, wherein the cover shell is further provided with filling ports connected to the first working chamber and the second working chamber; a bottom side of the housing is further provided with drain ports connected to the first working chamber and the second working chamber; each of the filling ports and the drain ports is provided with a reusable sealing cap.

8. The composite module of claim 6, wherein a sealing gasket is further disposed between the hollow battery core body and the cover shell, and another sealing gasket is further disposed between the hollow battery core body and an inner bottom surface of the accommodating cavity.

9. The composite module of claim 6, wherein a periphery of each of the fixing plates is further provided with positioning projections that are in abutment with an inner side wall of the accommodating cavity.

10. The composite module of claim 1, wherein each of the first ultrasonic electrode cores and the second ultrasonic electrode cores comprises an elongated housing with an operating groove, a slidable block disposed in the operating groove, and an elongated cover shell covering the operating groove; the slidable block is provided with at least one permanent magnet; at least one electromagnetic coil interacting with said at least one permanent magnet is arranged at an inner side of the elongated cover shell; resilient tabs providing a buffering function are arranged at two ends of the slidable block respectively; outer surfaces of the elongated housing and the elongated cover shell are coated with conductive coating.
